(19) United States
(12) Patent Application Publication
(10) Pub. No.: US 2009/0008320 A1
(43) Pub. Date: Jan. 8, 2009

(54) Fluid Filter and Methods

(75) Inventors: David B. Harder, Burnsville, MN (US); Gus E. Breiland, Minneapolis, MN (US); John Francis Connelly, Chanhassen, MN (US)

Correspondence Address: MERCHANT & GOULD PC, P.O. BOX 2903, MINNEAPOLIS, MN, 55402-0903, US

(73) Assignee: DONALDSON COMPANY INC., Ninneapolis, MN (US)

(21) Appl. No.: 11/720,486

(22) PCT Filed: Jan. 16, 2006
(86) PCT No.: PCT/US06/01415

§ 371 Date: Jul. 8, 2008

Related U.S. Application Data
(60) Provisional application No. 60/645,334, filed on Jan. 18, 2005.

(51) Int. Cl. B01D 35/30; B01D 27/08

(52) U.S. Cl. 210/440; 210/455; 210/457

(57) ABSTRACT

A fluid filter arrangement includes a housing defining a slot arrangement. A filter cartridge is oriented within the housing. A projection arrangement engages the slot arrangement in the housing and spaces the filter cartridge from a wall of the housing to define a fluid flow path between the cartridge and the housing wall. A filter cartridge includes a tubular construction of filter media and a projection arrangement. A filter assembly includes the filter arrangement connected to a filter head. Preferably, the filter cartridge and filter head are made of plastic. Methods of assembling a filter includes inserting a filter cartridge and projection arrangement into an open end of a housing, engaging projections against through-slots defined by the housing to secure the filter cartridge in the housing. In some arrangements, a filter housing includes a plastic wall having an interior side with a support structure in the form of ribs extending from the interior side of the housing. In some arrangements, the plastic filter head is modular and may include male threads molded as part of the filter head.

This application is being filed on 16 Jan. 2006, as a PCT International Patent application in the name of Donaldson Company, Inc., a U.S. national corporation, applicant for the designation of all countries except the US, and David B. Harder, Gus E. Breiland, and John Francis Connelly, all citizens of the US, applicants for the designation of the US only, and claims priority to U.S. Provisional Application Ser. No. 60/645,334, filed Jan. 18, 2004.

### TECHNICAL FIELD

This disclosure relates to fluid filtration, filter elements, cartridges, systems, methods of manufacture, methods of assembly, and use. In particular, this disclosure concerns filters, filter cartridges, and methods for purifying fluids for uses in connection with, for example, engines or industrial applications. Such applications may include lubrication filters, hydraulic filters, fuel filters, and spin-on filters for fluids.

### BACKGROUND

Filtration is needed in order to purify fluids to protect equipment. Filtration is used in, for example, internal combustion engine systems, hydraulic systems, compressors, generators, and others. In typical systems, the filtration is accomplished by using a filter device having some sort of filtration media. After a period of use, the filter media becomes clogged, and the restriction across the media rises to an unacceptable level. At that time, the filter device needs to be serviced. In some systems, the entire filter device is disposed of and replaced with a new filter device. In some systems, only certain internal components of the filter device are replaced. Still in other systems, the filter media is merely cleaned out.

One type of filter is a spin-on filter. Spin-on filters are disposable units, which typically include a single use housing holding a permanently mounted, non-replaceable filter element (or filter cartridge). The canister holding the filter cartridge is usually spun onto a filter head by threaded engagement. The fluid to be cleaned passes from the filter head and into the housing for filtering. The cleaned liquid exits the housing then re-enters the filter head. After some period of use, the spin-on canister filter is removed from the filter head and is discarded. A new spin-on canister filter is then mounted onto the filter head.

Ways to reduce the manufacturing costs and the convenience and ease of use continue to be desirable. Improvements in other areas for filtration devices, methods of assembly, methods of manufacturing, and methods of use are also desirable.

### SUMMARY

A fluid filter arrangement includes a housing defining a slot arrangement. A filter cartridge is oriented within the housing. A projection arrangement is constructed and arranged to engage the slot arrangement in the housing and space the filter cartridge from a wall of the housing to define a fluid flow path between the cartridge and the housing wall.

In one example embodiment, the projection arrangement includes a plurality of projections, each of which includes a pair of wings flexibly secured to the filter cartridge.

In one embodiment, the housing comprises a molded plastic.

In one embodiment, the housing includes a support arrangement along a side of the wall facing the interior volume, which is constructed and arranged to support the filter cartridge.

In one embodiment, the support arrangement includes a plurality of ribs extending into the interior volume.

A filter cartridge is provided including a tubular construction of filter media defining an open interior volume and a projection arrangement. The projection arrangement includes a plurality of projections in radial extension from the tubular construction. At least some of the projections of the plurality of projections includes a pair of wings flexibly secured to the tubular construction.

In another aspect, a filter assembly is provided including a fluid filter arrangement, as characterized above, and including a filter head having a fluid flow inlet port and fluid flow outlet port. The filter arrangement is releasably secured to the filter head.

In one embodiment, the filter head comprises plastic.

In another aspect, a method of assembling a filter is provided. The method includes inserting a filter cartridge and a projection arrangement into an open end of a housing. The method further includes engaging projections on the projection arrangement against an arrangement of through slots defined by the housing to secure the filter cartridge in the housing.

In other aspect, a filter housing is provided including a plastic wall surrounding an interior volume and having a closed end and an open mouth. The wall has an interior side in communication with the interior volume. A plurality of ribs extend from the interior from the interior side and into the interior volume.

In one embodiment, each rib of the plurality of ribs is generally parallel to adjacent ribs.

In one embodiment, each rib of the plurality of ribs extends obliquely along the interior side.

In another aspect, a filter head is disclosed including a molded plastic block having a center tube, an outer tube, and defining a first fluid flow passageway, and a second fluid flow passageway. The outer tube circumscribes the center tube. The first fluid flow passageway has a first port. The second fluid flow passageway has a second port. The outer tube defines an end, an outer tube and a port at the end, and an outer tube flow passageway between the first fluid flow passageway and the outer tube end port. The center tube defines a center tube flow passageway and a center tube end port. The center tube flow passageway is between the center tube end port and the second fluid flow passageway.

In one embodiment, there are externally directed male threads surrounding the first fluid port, which are part of a same molded piece as the molded plastic block. In some embodiments, there is also externally directed male threads surrounding the second fluid port.

### BRIEF DESCRIPTION OF THE DRAWINGS

FIG. 1 is a perspective view of a filter including a housing or can and a filter cartridge constructed according to principles of this disclosure;

FIG. 2 is a perspective, cross-sectional view of the filter depicted in FIG. 1;

FIG. 3 is a perspective, cross-sectional view of a filter cartridge depicted in FIGS. 1 and 2;

FIG. 4 is a perspective, cross-sectional view of the filter housing depicted in FIGS. 1 and 2;

FIG. 5 is a schematic, cross-sectional view of a mold and a method used for making the filter housing depicted in FIGS. 1, 2, and 4;

FIG. 6 is a perspective view of the filter cartridge depicted in FIGS. 1 and 2;

FIG. 7 is a perspective, cross-sectional view of a second embodiment of a filter including a filter housing and filter cartridge, constructed according to principles of this disclosure;

FIG. 8 is a perspective, cross-sectional view of the filter housing depicted in FIG. 7;

FIG. 9 is a perspective, cross-sectional view of the filter of FIG. 1 operably mounted to a filter head;

FIG. 10 is a cross-sectional view of the filter mounted to a filter head depicted in FIG. 9;

FIG. 11 is a cross-sectional view of the filter head depicted in FIGS. 9 and 10;

FIG. 12 is a cross-sectional view of another embodiment of a filter head secured to a filter, and including additional valve structure;

FIG. 13 is a cross-sectional view of another embodiment of a filter head and filter including additional valve structure;

FIG. 14 is a cross-sectional view of the filter assembly of FIG. 13, and showing one of the valves in an open position;

FIG. 15 is an exploded, perspective, schematic view of a portion of the filter head and depicting a pocket in the filter head to receive a fastener;

FIG. 16 is a side elevational view of the assembly of FIG. 16 after assembly; and

FIG. 17 is a cross-sectional view of the assembly of FIGS. 15 and 16.

### DETAILED DESCRIPTION

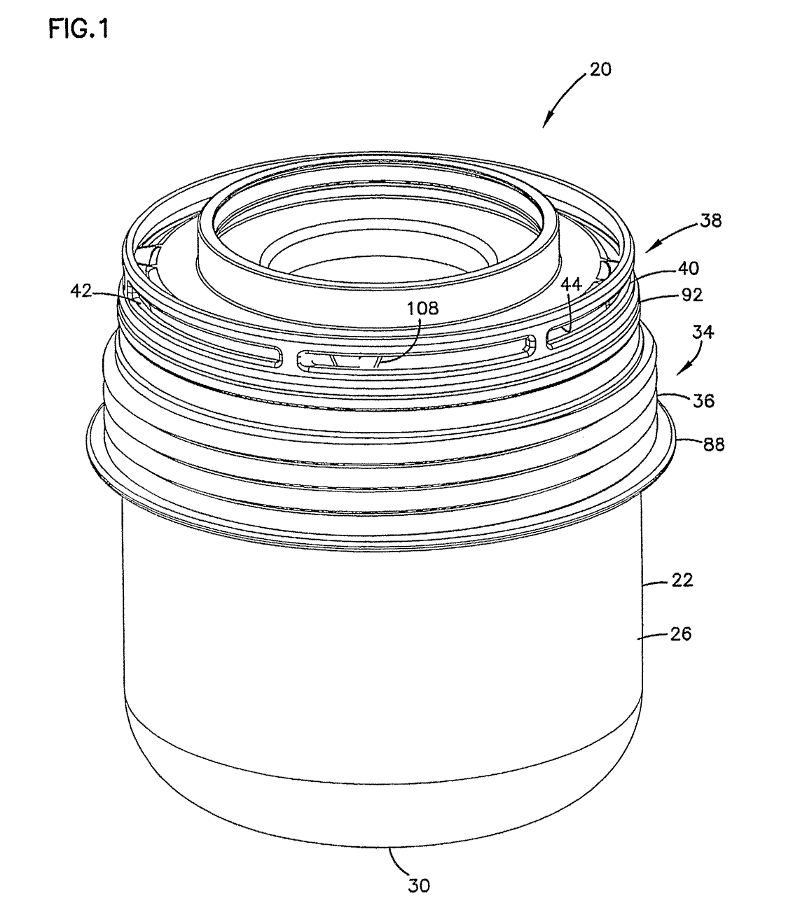

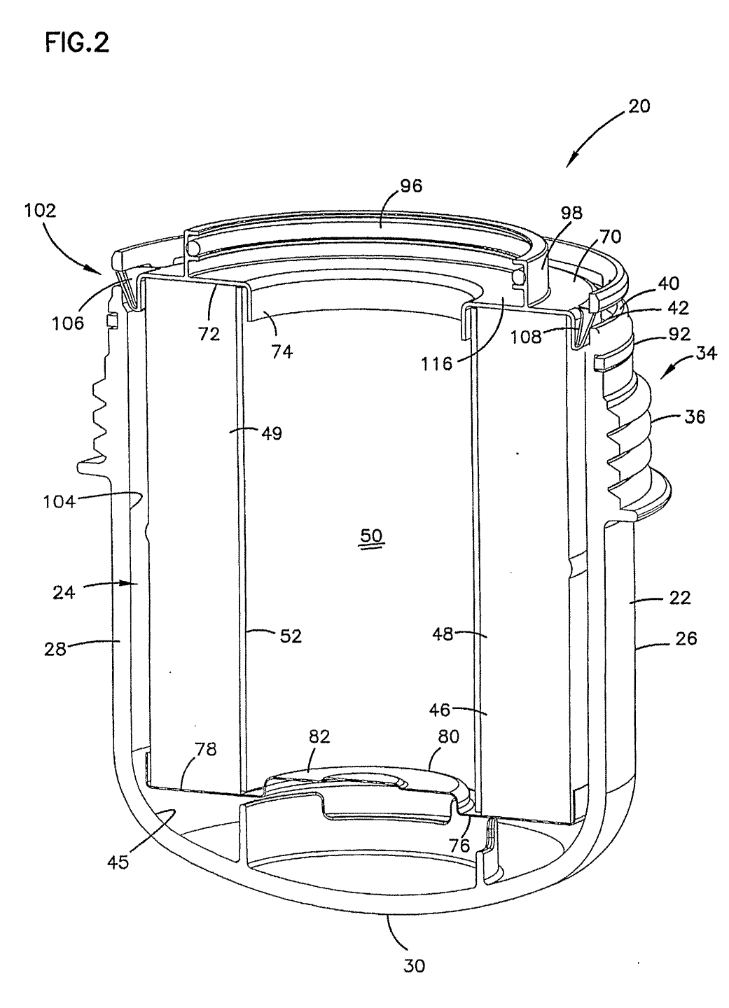

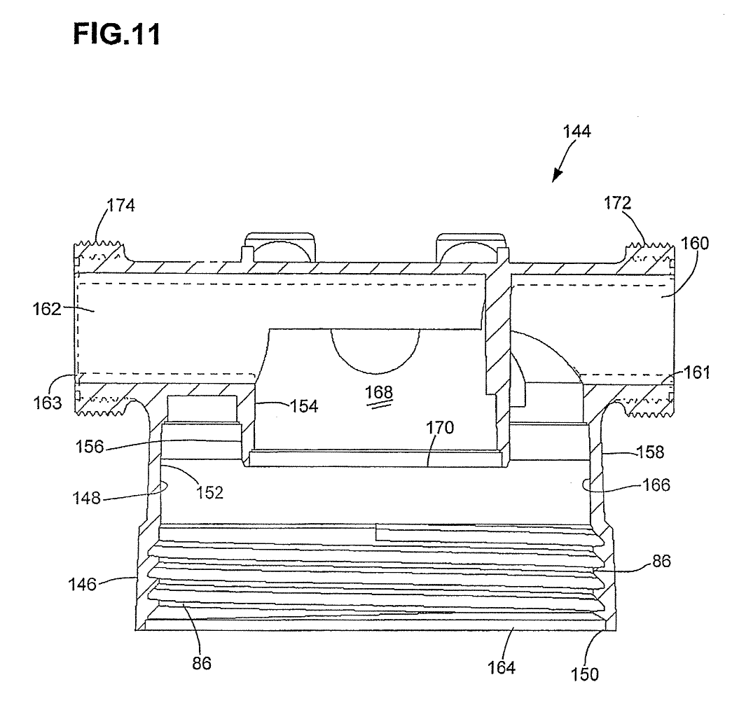

The first embodiment of a fluid filter arrangement is depicted in FIGS. 1 and 2 generally at 20. By the term “filter arrangement” or “filter”, it is meant, generally, an arrangement including a housing and a filter cartridge or filter element therein. The filter cartridge can either be removable and replaceable from the housing or permanently mounted within the housing. By “permanently mounted”, it is meant that the cartridge or element cannot be removed and replaced from the housing without damaging either the housing or the filter element. The filter arrangement 20, in the example depicted, is removable and replaceable from a filter head, one example of which is depicted in FIG. 11 and described further below.

In the embodiment shown, the filter arrangement 20 includes a can or housing 22 and a filter element or filter cartridge 24 oriented therewithin. In the embodiment shown, the filter housing 22 is embodied in the form of a can 26 having a surrounding wall 28 (FIG. 2). The can 26 defines a closed end 30 and an open mouth or end 32. The can 26 may be many different shapes. For purposes of illustration here, the can 26 is generally cylindrical having a circular cross-section.

Other features of the housing 22 includes a mechanism 34 for securing the filter arrangement 20 to a filter head. In the embodiment shown, the mechanism 34 is in the form of threads 36. In the particular embodiment shown, the threads 36 are externally directed. In other embodiments, the threads 36 could be internal threads.

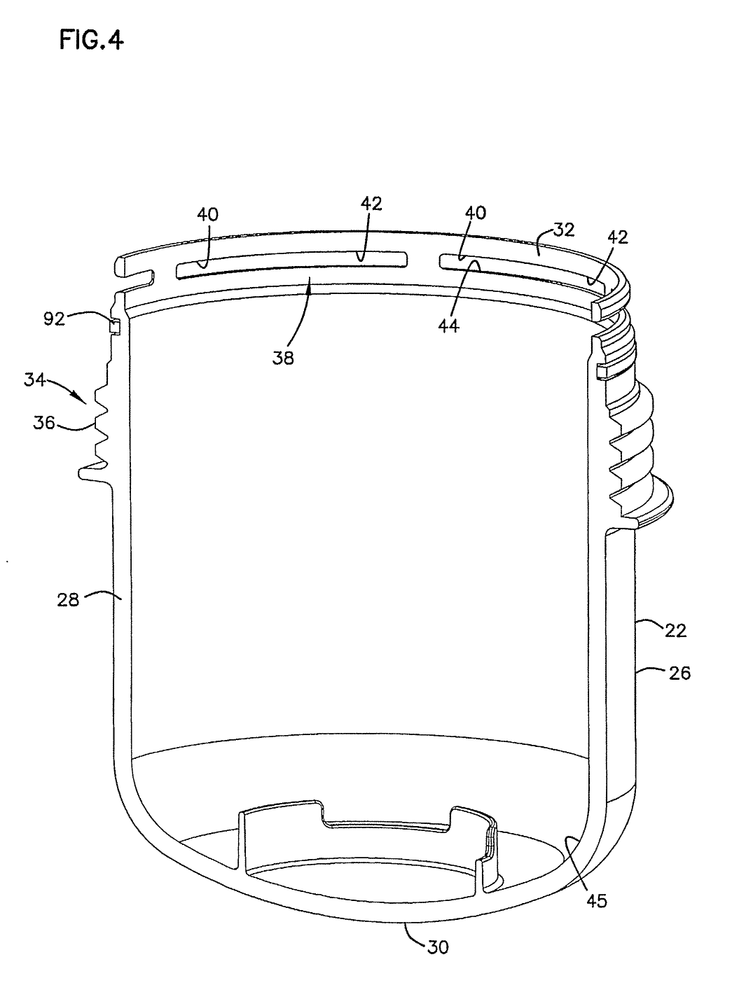

The filter housing 22 further includes a slot arrangement 38 (FIGS. 1, 4). In the embodiment shown, the slot arrangement 38 includes a plurality of slots 40. Preferably, there would be at least two slots 40, in some embodiments at least three slots 40, and in some embodiments at least four slots 40. The slots 40 can be through-slots or not through-slots. By the word “through-slot”, it is meant that there is a hole that extends completely through the wall 28 of the housing 22 in the region of the slot. Slots that are not through-slots mean that there is a region of indented material in the wall 28 of the housing 22, but the slot does not go completely through the wall 28. In the embodiment shown, and in preferred embodiments, the slots 40 are each through-slots 42. In the particular arrangement shown, the through-slots 42 are each closed slots. By the term “closed slots”, it is meant that the hole 44 (FIG. 4) defined by each slot 40 is completely surrounded by wall material 28; that is, there is a complete, closed perimeter around each hole 44. The function of the slot arrangement 38 is described further below. Advantageous manufacturing techniques for using through-slots 42 are also further described.

The element or cartridge 24 is shown operably oriented within an interior 45 of the housing 22 (FIG. 2). The cartridge 24 includes, in this embodiment, a region of filter media 46. In this embodiment, the filter media 46 is in a tubular form. The filter media may be many different types of media including, for example, pleated media 48. The pleated media 48 includes a plurality of pleats 49 in extension generally between the closed end 30 and the open end 32 of the housing 22 and arranged in a tubular orientation to define an open interior volume 50. Types of pleated media 48 that can be used include paper, cellulose, synthetic media, and combinations thereof. In some applications, the media 46 can be treated with fine fiber, sized on the order of micron or submicron (fiber diameter).

In some arrangements, the filter cartridge 24 is supported by a filter support. In some embodiments, particularly in forward flow arrangements, the filter support will be in the form of an inner liner that is circumscribed by the filter media. Forward flow arrangements include arrangements in which the fluid to be filtered flows from the outside of the filter cartridge 24, through the filter media 46, and into the interior volume 50. An example of an inner liner is shown in FIG. 2 at reference numeral 52 extending the length of the filter cartridge 24. The inner liner 52 may be constructed from expanded metal, perforated metal, or other materials (including non-metallic) allowing for permeability and flow therethrough. In other arrangements, such as reverse-flow arrangements, the filter support will be in the form of an outer liner that is positioned to circumscribe and surround the filter media 46.

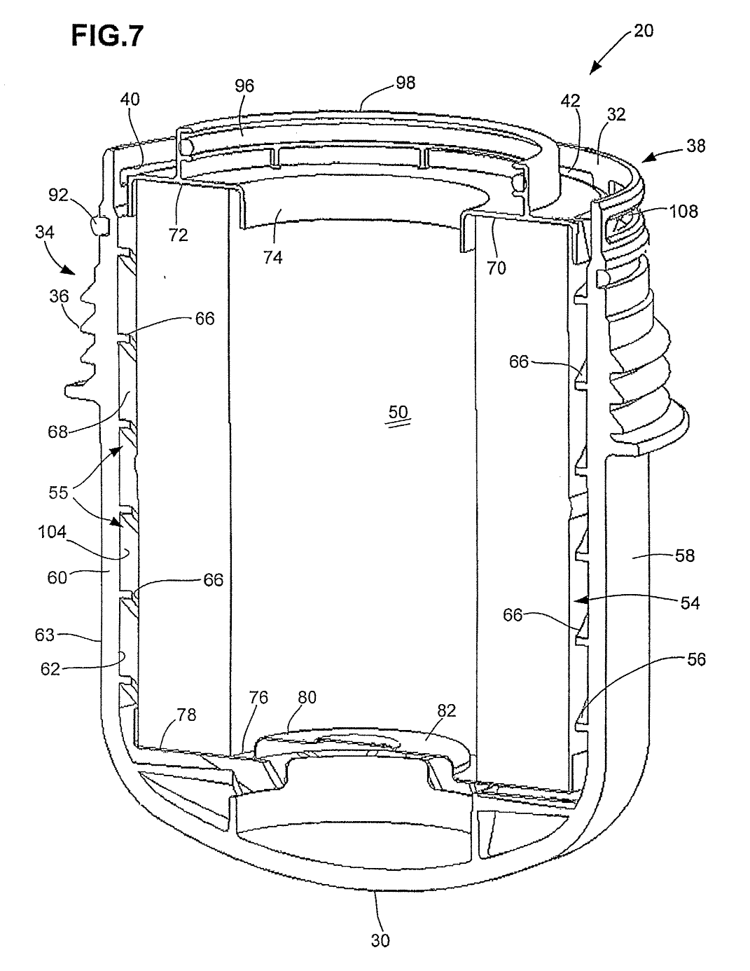

FIG. 7 shows an embodiment of a reverse-flow filter cartridge 54. In this arrangement, the outer filter support 55 is in the form of a rib arrangement 56. The rib arrangement 56, in the embodiment shown, is integral with the housing 58 and helps to support the filter media 46 on the downstream side.

In particular, in FIG. 7, the housing 58 includes a housing wall 60 with an interior side 62 and an exterior side 63. The interior side 62 faces the interior volume 64 of the housing 58. Projecting from the interior side 62 of the wall 60 are a plurality of ribs 66. The ribs 66 support the downstream side of the filter media 46.

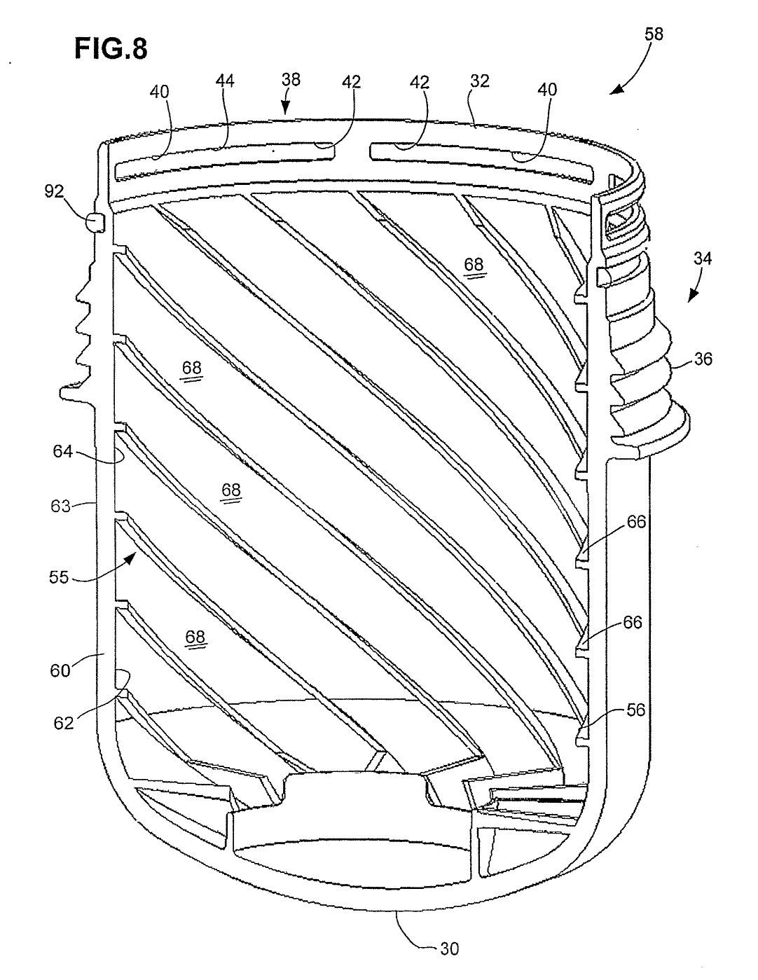

In the embodiment shown in FIGS. 7 and 8, the ribs 66 are arranged to be generally parallel to each other. In preferred embodiments, the ribs 66 are arranged to be oblique along the interior side 62 of the wall 60. By oblique, it is meant that the ribs 66 do not extend longitudinally or horizontally, but are angled along the interior side 62. In preferred embodiments, the ribs 66 are arranged in a spiral pattern. Between each rib 66 is a fluid flow path 68. The fluid flow paths 68 help to direct the cleaned fluid from the housing 22 back into a filter head.

In preferred embodiments, each rib 66 projects from the interior side 62 of the housing 58 by at least 0.5 mm, not greater than 25% of the diameter of the housing 58, and typically about 1-6 mm.

In reference again to the filter cartridge 24 shown in FIGS. 2, 3, 6, and 7, the filter cartridge 24 depicted includes at least one end cover or end cap 70. In the embodiment shown, the end cap 70 is secured to a first end 72 of the filter media 46. The end cap 70, in the embodiment shown, defines a hole or aperture 74 that is in fluid communication with the open interior volume 50. Further details regarding preferred end caps 70 are described further below.

In the embodiment shown, there is also a second end cover or end cap 76. The second end cap 76 is secured to a second end 78 of the filter media 46. The second end cap 76, in the embodiment shown, is closed and defines no openings. In particular, the second end cap 76 is secured to the second end 78 of the filter media 46 and covers or closes the open interior volume 50 through a section 80. In the embodiment shown, the section 80 includes a raised platform 82 that extends into the open interior volume 50 to be circumscribed or surrounded by the filter media 46. The section 80 also engages support structure 84 oriented extending from an interior portion of the closed end 30 of the housing 22. In this particular arrangement, the filter 20 is springless, that is, there is no biasing mechanism such as a spring within the housing 22.

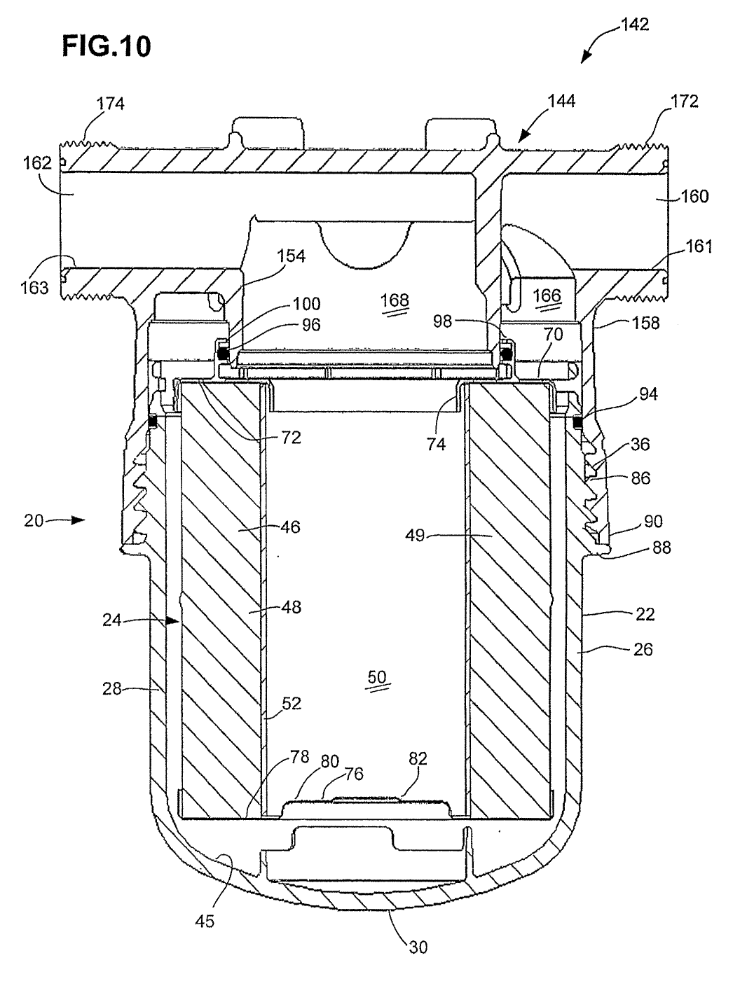

As mentioned above, the filter arrangement 20 includes connection mechanism 34, embodied as threads 36 for securing the filter arrangement 20 to a filter head. In FIG. 10, a filter assembly is shown, generally, at 142 and includes a filter head 144 with the filter arrangement 20 removably secured thereto. The filter head 144 will be described in further detail below. In the embodiment shown, the filter head 144 includes internally directed threads 86 that mate or engage with the threads 36. In the embodiment shown, the housing 22 includes a flange 88 acting as a stop 90 for the threaded connection. The flange 88 extends orthogonally to the wall 28 of the housing 22. When the filter arrangement 20 is mounted onto the filter head 144 by rotating the housing 22 with threads 36 relative to the filter head 144 with threads 86, the rotation will be permitted until the filter head 144 engages against the flange 88 (i.e., “bottoms-out” against the flange 88). The flange 88 is located relative to other portions of the filter arrangement 20 to ensure that seals are in place. The seals are discussed below.

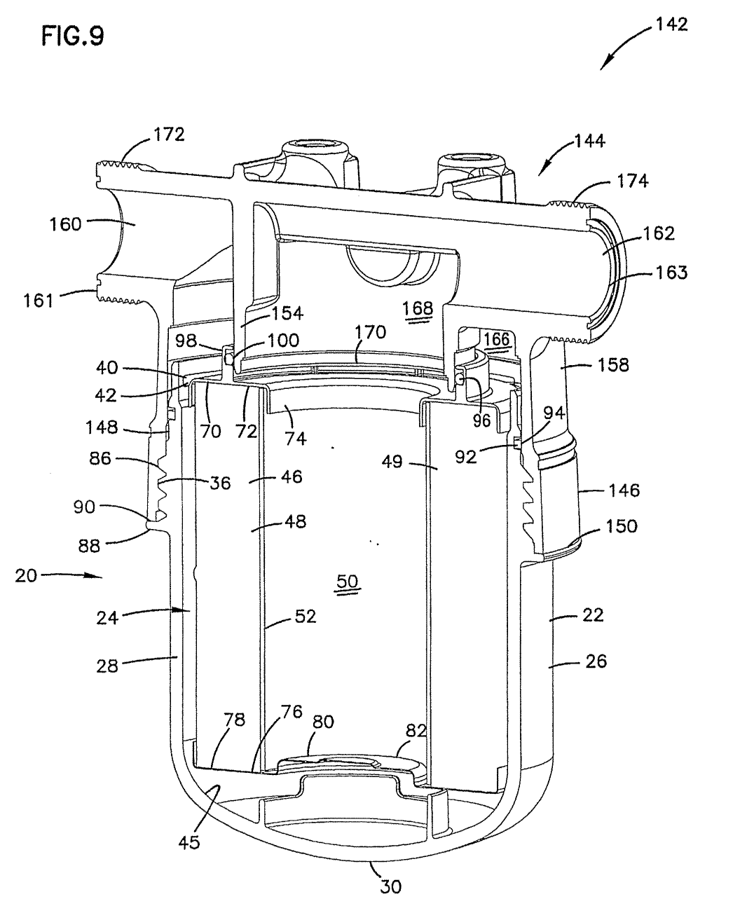

The filter housing 22 includes a first seal member 92 to form a seal 94 (FIG. 9) between the housing 22 and the filter head 144. The location of the seal member 92 is a matter of choice, and in the illustrated embodiment, the first seal member 92 is located in the wall 28 to form a radially directed seal with a radial surface of the filter head 144. In particular, and in reference now to FIG. 11, the filter head 144 has an outer, tubular wall 146 with an internally directed surface 148. The outer tubular wall 146 has a free end 150, which engages against the flange 88 when the filter arrangement 20 is operably mounted to the filter head 144. Adjacent to the free end 150 are the threads 86. Located next to the threads and remote from the free end 150 along the internally directed surface 148 is a sealing surface 152. The seal 94 is formed by compression of the first seal member 92 against the sealing surface 152.

In the arrangement shown, there is a second seal member 96 between the filter arrangement 20 and the filter head 144. The seal location is a matter of choice, as long as unfiltered liquid is kept separate from filtered liquid. In the embodiment shown, the second seal member 96 is secured to the filter cartridge 24. The particular second seal member 96 is located secured to the first end cap 70. The particular second seal member 96 illustrated is located extending axially from the first end cap 70 and held by a C-shaped holder 98 such that the second seal member 96 is oriented to form a radially directed seal 100 (FIG. 9) with the filter head 144. Specifically, in the embodiment shown in FIG. 11, the filter head 144 has a center tube 154, which is circumscribed by the outer tube 146. The center tube 154 has an external wall surface 156. The seal 100 is formed by compression of the second seal member 96 against the external wall surface 156 of the center tube 154.

Again, while location of the second seal member 96 is a matter of choice, in the particular arrangement shown, the second seal member 96 is located about in the center of the end cap 72. Further, the second seal member 96 can be located to provide a larger seal diameter (DsA) than a diameter of the aperture 74 of the end cap 70, in which DsA is within the range of 0.85-1.15 DbA, inclusive, wherein: DbA is a diameter at which no net axial surface force on the first end cap 70 toward or away from the second end cap 76, in use, results. This is defined in commonly assigned U.S. provisional patent application 60/562,045, filed on Apr. 13, 2004, which disclosure is incorporated herein by reference in its entirety. This particular location would be a location that gives a net force of zero on the first end cap 70.

The filter arrangement 20 includes a projection arrangement 102 that is constructed and arranged to space the filter cartridge 24 from the housing wall 28 to define a fluid flow path between the filter cartridge 24 and the housing wall 28. In the illustrated embodiment, the projection arrangement 102 engages the slot arrangement 38 in the housing wall 28. The way one embodiment works can be seen by reviewing FIG. 2. Fluid to be cleaned is directed into the filter arrangement 20. In a reverse-flow arrangement, the fluid flows into the open interior volume 50 within the interior of the filter cartridge 24. The fluid then flows through the filter media 46 and into the volume or space 104 between the filter media 46 and the wall 28. The clean fluid then flows out of the filter cartridge 24 and into the filter head 144. The projection arrangement 102 spaces the filter cartridge 24 from the wall 28 of the housing 22 in order to allow a fluid path for the fluid to flow to get to the volume or space 104 outside of the region of the filter media 46. The filter arrangement 20 is also operable in a forward-flow arrangement. In a forward-flow arrangement, the fluid first flows into the space 104, then through the filter media 46, and then into the open interior volume 50, and finally into the filter head 144.

The projection arrangement 102 can be in a variety of embodiments. In the arrangement 102 that is illustrated, the projection arrangement 102 includes more than one projection 106 extending from the filter cartridge 24. Preferably, there are at least two projections 106. In more preferred embodiments, there are at least three projections 106. In the particular embodiment illustrated, there are four projections 106.

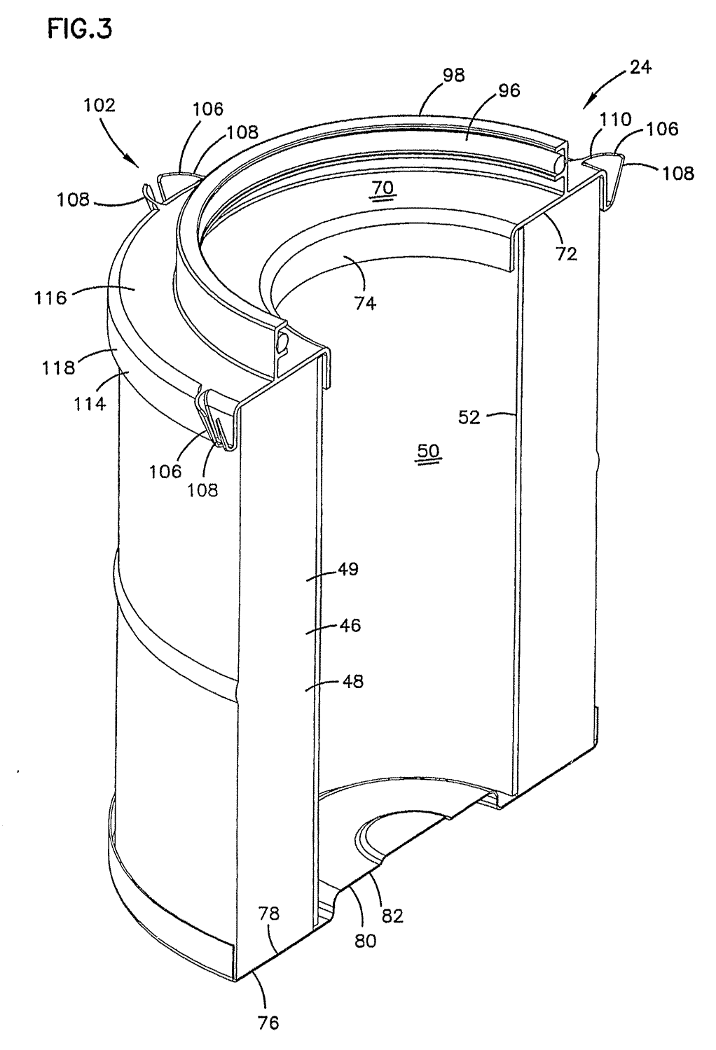

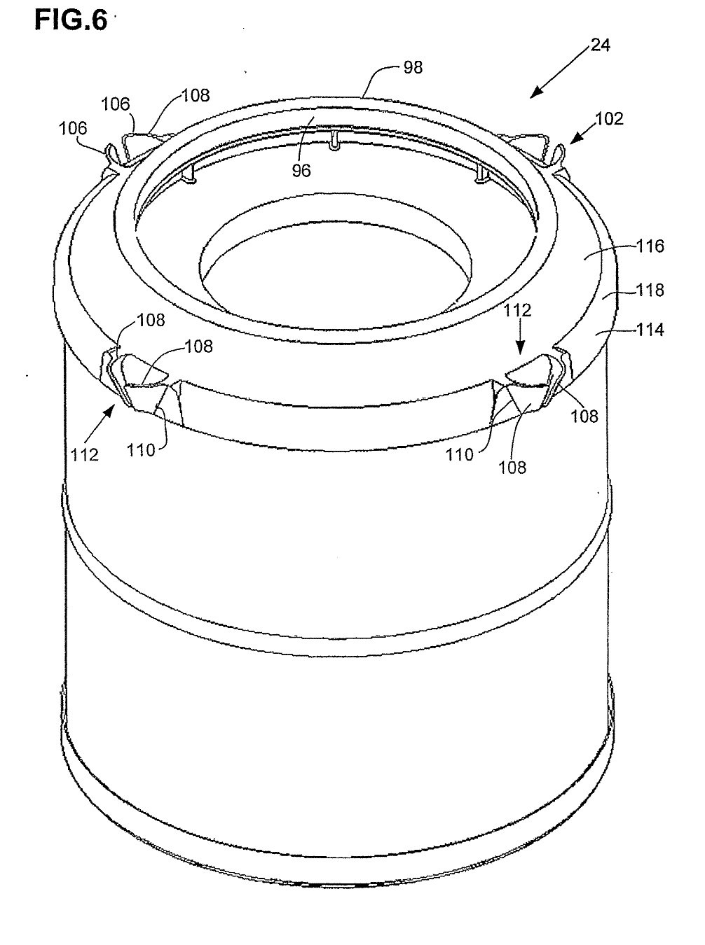

In the specific illustrated embodiment in FIGS. 3 and 6, each of the projections 106 includes at least one wing 108 flexibly secured to the filter cartridge 24. The specific embodiment illustrated shows that each projection 106 has a pair of wings 108 flexibly secured to the filter cartridge. By “flexibly secured”, it is meant that the wings 108 will elastically deform along a joint 110 (FIG. 6) connecting each wing 108 to the filter cartridge 24 when subject to a small force, typically a force of under 10 lbs. As can be seen in FIG. 6, each wing 108 is secured to the filter cartridge 24 along joint 110 that is angled or oblique relative to a remaining part of the filter cartridge 24. In the specific embodiment illustrated, each of the projections 106 includes a pair of wings 108, flexibly secured to the filter cartridge 24, and forming a V-shape projection 112. Upon insertion of the filter cartridge 24 into the interior of the housing 22, the wings 108 will be pressed radially inwardly toward the filter cartridge 24 along the joints 110. This will allow the cartridge 24 to be inserted into the housing 22. When the V-shape projections 112 reach the through slots 42 in the housing 22, the wings 108 will flex back along the joints 110 to their original position and catch the perimeter of the through slots 42. This engagement between the projections 106 and the through slots 42 will mechanically lock the filter cartridge 24 in the housing 22.

In reference to FIG. 6, in the particular arrangement shown, the projections 106 are secured to the first end cap 70. Specifically, in the embodiment shown, the projections 106 are radially secured to the first end cap 70. In FIG. 6, each of the joints 110 is along a radial portion 114 of the first end cap 70.

In particular, the first end cap 70 includes a base 116 and a side wall 118, which corresponds to the radial portion 114. The side wall 118 circumscribes the filter media 46. The side wall 118 is generally orthogonal to the base 116. In the embodiment shown, the projections 106 extend radially from the side wall 118 of the end cap 70.

In the example embodiment, each of the projections 106 includes the pair of wings 108. As illustrated, in this embodiment, there are eight wings 108. This provides eight points of contact between the filter cartridge 24 and the housing 22. That is, each wing 108 engages the through slots 42 (FIG. 2). If, for some reason, there is a failure of one wing 108, the other seven wings 108 would still be in place to ensure that the filter cartridge 24 stays in place relative to the housing 22.

In addition, because each joint 110 is oblique relative to the side wall 118 of the end cap 70, and each pair of joints 110 for each pair of wings 108 forms a V-shape, this arrangement is less likely to result in breakage along the joints 110 from operational forces, than if the joints 110 were oriented to be horizontal relative to the remaining portion of the filter cartridge 24.

Still in reference to FIG. 6, in the particular embodiment illustrated, each wing 108 has a generally trapezoidal shape, with one side of the trapezoid corresponding to the joint 110. When the projections 106 are in a resting condition, such as that shown in FIG. 6, the projections 106 radially extend from the side wall 118 of the end cap 70 by a distance of at least 1 mm, no greater than 25% of the diameter of the cartridge 24 (without the projections 106), and typically 4-7 mm. The existence of the projections 106 makes the overall diameter of the filter cartridge 24 larger by not more than 25%, as compared to the filter cartridge 24 without the projections 106.

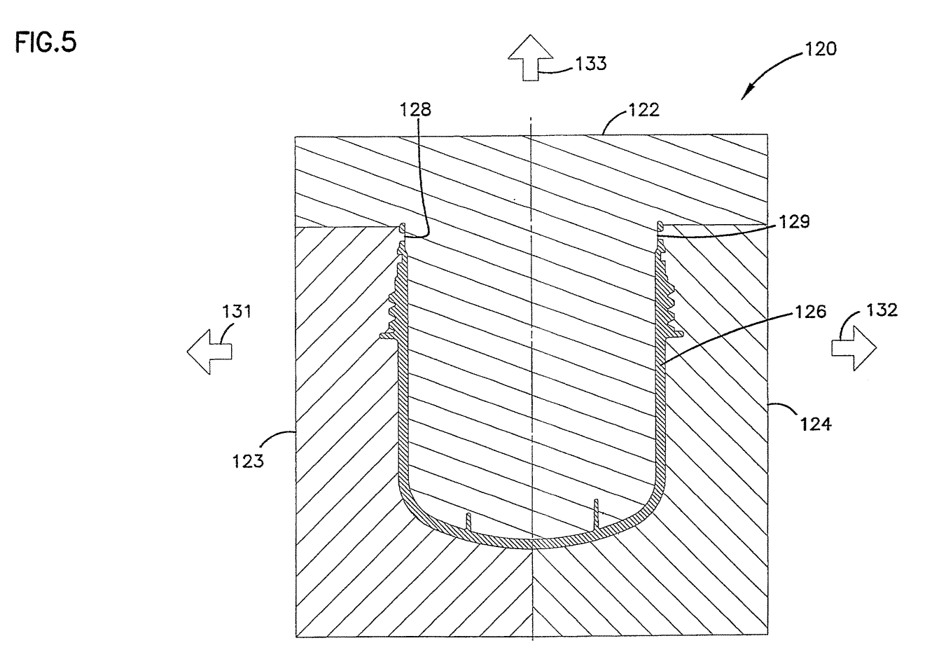

The filter housing 22 can be made from a variety of materials, including metal or non-metal. If made from non-metal, it is preferably made from plastic. One method of making the housing 22 is by using an injection molding process. Attention is directed to FIG. 5. FIG. 5 shows, schematically, a process for injection molding the housing 22 from plastic. In FIG. 5, a mold assembly is shown at 120. By using through slots 42 in the housing 22, instead of other types of arrangements (such as an undercut or ledge on the inside diameter of the housing 22), the housing 22 can be injection molded without using a collapsible core. This allows for a less expensive and simpler tool than in other types of systems.

The mold assembly 120 in FIG. 5 includes a center core mold piece 122 and first and second side pieces 123, 124. Molten plastic material 126 is injected into the mold assembly 120 and occupies the space or gap between the center piece 122 and side pieces 123, 124. The through-slots 42 are formed through the engagement at 128, 129 between the first side piece 123 and the core piece 122, and between the second side piece 124 and the center core piece 122. After the plastic material 126 hardens or cures, the side mold pieces 123, 124 are moved laterally in the direction of arrows 131, 132, while the center mold piece 122 is moved away axially in the direction of arrow 133. This results in the housing 22. Preferred materials include plastic, such as 33% glass-filled nylon available from DuPont as product designation Zytel 70G33HS1L. Other useable plastics include: polyphenylene sulfide, polybutylene terephthallate, and polyphthalamide.

To assemble the filter arrangement 20 of FIGS. 1, 2, and 7, the filter cartridge 24 including the projection arrangement 102 is inserted into the open end or mouth 32 (FIG. 4) of the housing 22, 58. The projections 106 are engaged against an arrangement of through-slots 42 defined by the housing 22, 58 to secure the filter cartridge 24 in the housing 22, 58. Specifically, the step of engaging projections on the projection arrangement 102 includes the wings 108 flexing along joints 110 to bend radially inwardly toward a remaining portion of the filter cartridge 24 and then flex outwardly to catch the holes 44 in the through-slots 42 to lock the cartridge 24 in the housing 22.

Turning now to FIGS. 9-12, a first embodiment of the filter assembly 142 is illustrated. The filter assembly 142 includes the filter head 144 operably connected to the filter arrangement 20. As described previously, a first seal 94 is formed between the wall 28 of the housing 22 and the internally directed surface 148 of the outer tubular wall 146 of the filter head 144. A second seal 100 is formed between the filter cartridge 24 and the external wall surface 156 of the center tubular wall 154 of the filter head 144. To be “operably assembled”, both the first seal 94 and the second seal 100 are in place, according to this particular illustrated embodiment.

A variety of filter heads 144 can be used. One example filter head 144 is shown in FIGS. 9-11 and is preferably constructed of plastic. In particular, the filter head 144 includes a molded plastic block 158. The molded plastic block 158, in the embodiment shown, includes the outer tube 146, and the center tube 154 that is circumscribed by the outer tube 146. The molded plastic block 158 defines a first fluid flow passageway 160 terminating at a first port 161. The particular illustrated molded plastic block 158 further includes a second fluid flow passageway 162 terminating at a second port 163. In the illustrated embodiment, the outer tube 146 defines the free end 150 and has an outer tube end port 164 (FIG. 11) at the free end 150. There is an outer tube flow passageway 166 providing a fluid passage between the first fluid flow passageway 160 and the outer tube end port 164. In the illustrated embodiment, the center tube 154 defines a center tube flow passageway 168 terminating in a center tube end port 170. The center tube flow passageway 168 forms a passageway between the center tube end port 170 and the second fluid flow passageway 162.

Still in reference to FIGS. 9-12, the preferred filter head 144 is modular in that many different models can be built from the same base mold. In the embodiment of FIGS. 9-12, the filter head 144 illustrated includes externally directed male threads 172 surrounding the first fluid port 161. Preferably, the male threads 172 are molded as a same piece of material as the molded plastic block 158. In addition, the second port 163 will preferably have external male threads 174 surrounding it. By the term “male threads”, it is meant that the threads are externally directed; that is, the threads are on the exterior surface of the molded plastic block 158 as opposed to being internally within the fluid flow passageways 160, 162. The threads that are in the internal passageways are female threads. The advantage of having male threads 172, 174 allows the user to thread a male fitting onto the port 161, 163, while the other end of the fitting can be several different designs and sizes to fit up with hoses. For example, the opposite end of the fitting could be an O-ring face seal. It should be appreciated that because the plastic block 158 is molded, it is possible to mold a variety of different fittings onto the ports 161, 163, to produce different sized O-ring face seal ports from this same base mold. This contributes to saving costs of adding fittings between the filter head 144 and hoses.

One useable plastic for the filter head 144 is polyphthalamide available from DuPont as product designation Zytel HTN51G35HSL NC010. Other useable plastics include nylon, polyphenylene sulfide, and polybutylene terephthallate.

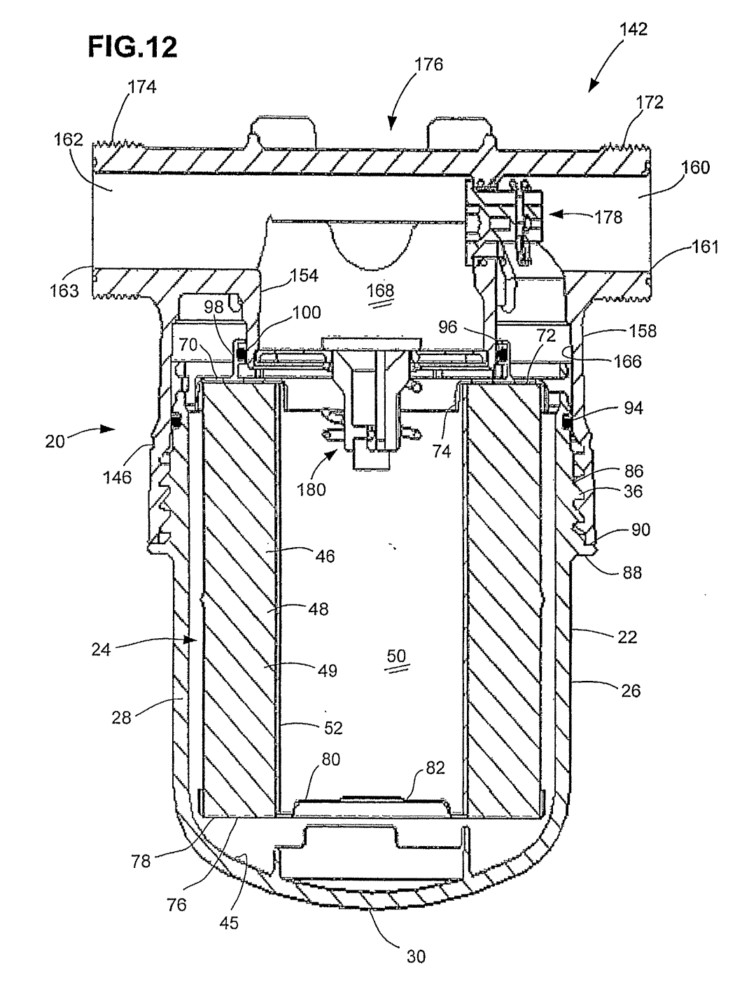

In reference now to FIG. 12, a second embodiment of a filter head is shown at 176. The filter head 176 has all of the same features as the filter head 144, and the description of the filter head 144 is incorporated herein by reference with respect to the filter head 176. The filter head 176 differs from the filter head 144 in that the filter head 176 includes a bypass valve 178. The bypass valve 178 can be incorporated into the filter head 176 by machining an opening between the center tube 154 and the first flow passageway 160, and then installing the valve 178. The bypass valve 178 allows fluid to bypass the filter media 46 to proceed directly from the unfiltered liquid side to the filtered liquid side; that is, from the first fluid flow passageway 160 to the second fluid flow passageway 162 without passing through the filter media 46. The bypass valve 178 is needed in cases of severe restriction across the filter media 46, or in the cases of surge conditions or cold starts. If it is desirable to have all non-metal pieces for the filter assembly 142, then the bypass valve 178 can be a plastic valve and a compression spring. The valve would be made from the same plastics used to make the filter housing.

The filter head 176 can also have an optional anti-drain valve 180. The anti-drain valve 180 keeps fluid, such as oil, from draining out of the filter head 176 during servicing. That is, when the filter assembly 142 is serviced by removing the filter arrangement 20 from the filter head 176, the anti-drain valve 180 stops the fluid from running out of the filter head 176. The anti-drainback valve 180 is inserted into the filter head 176, when desired. The valve can then be welded or snap-fit into the filter head 176. If desired, the anti-drainback valve may also be made of plastic using the same materials as the filter housing. In the embodiment of FIG. 12, the filter head 176 shows the anti-drainback valve 180 oriented in a forward flow system.

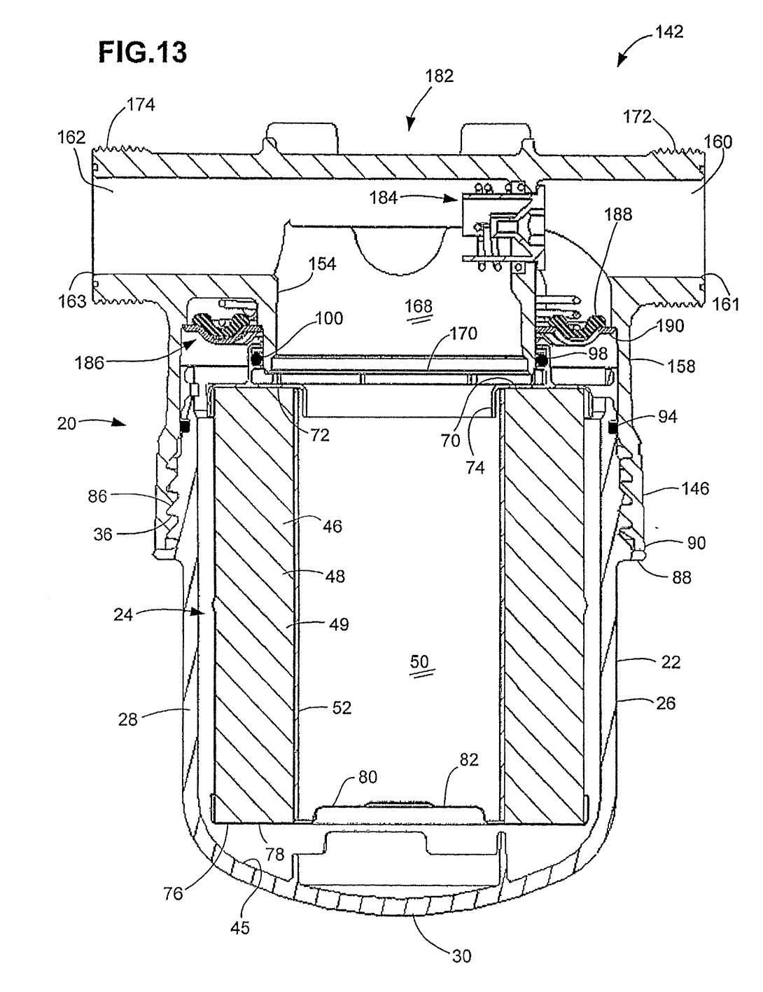

FIG. 13 illustrates another embodiment of a filter head 182. The filter head 182 has all of the features of the filter head 144, and the description of filter head 144 is incorporated herein by reference with respect to filter head 182. In addition, the filter head 182 includes a bypass valve 184 for a reverse-flow system. The filter head 182 can also have an optional anti-drainback valve 186. Again, the anti-drainback valve is interested into the filter head 182 and then connected by welding or a snap-fit.

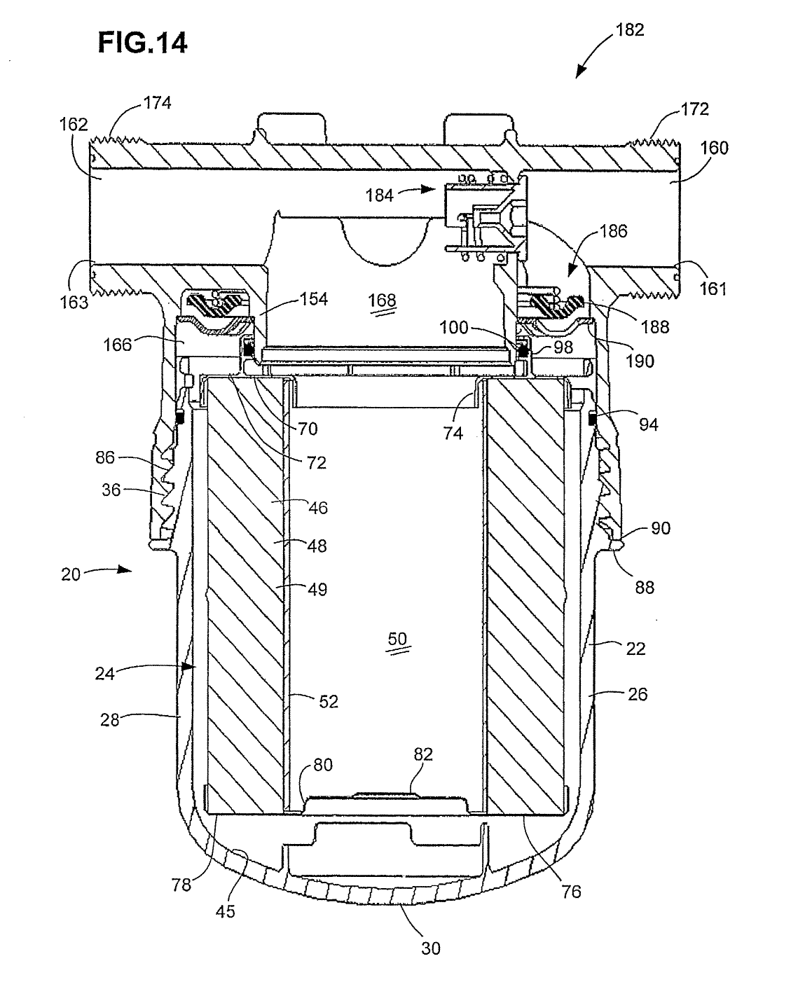

FIG. 13 shows the anti-drainback valve 186 in a closed position, while FIG. 14 shows the anti-drainback valve 186 in an open position. In FIG. 14, it can be seen that a seal member 188 is compressed away from the valve seat 190 in order to open the fluid flow path.

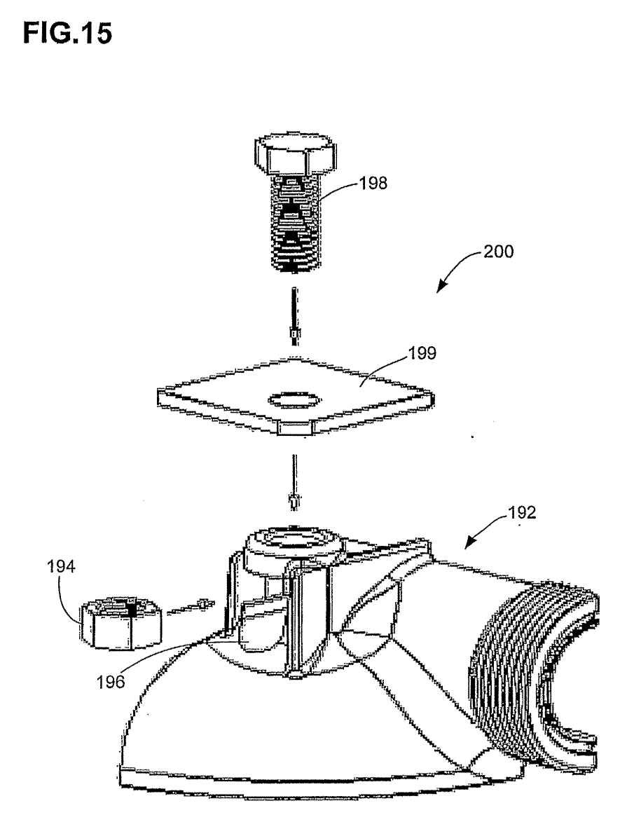

Attention is next directed to FIGS. 15-17. Another embodiment of a filter head 192 is partially shown, schematically, in FIGS. 15-17. The filter head 192 is preferably plastic and includes the features of the filter head 144, the description of which is incorporated herein by reference to apply to the filter 192. In FIGS. 15-17, the filter head 192 shows structure and a method for providing a strong thread for mounting. In particular, the filter head 192 uses steel hex nuts 194 inserted into the plastic filter head 192 after molding. In prior art methods, metal threads are inserted into plastic parts by insert molding or ultrasonic welding special threaded inserts into the plastic. That prior art method uses complex parts and is expensive. In filter head 192 of FIGS. 15-17, the filter head 192 includes a pocket 196 molded within the molded plastic block 158. The pocket then allows the steel hex nut 194 to be pressed in, by hand, after molding.

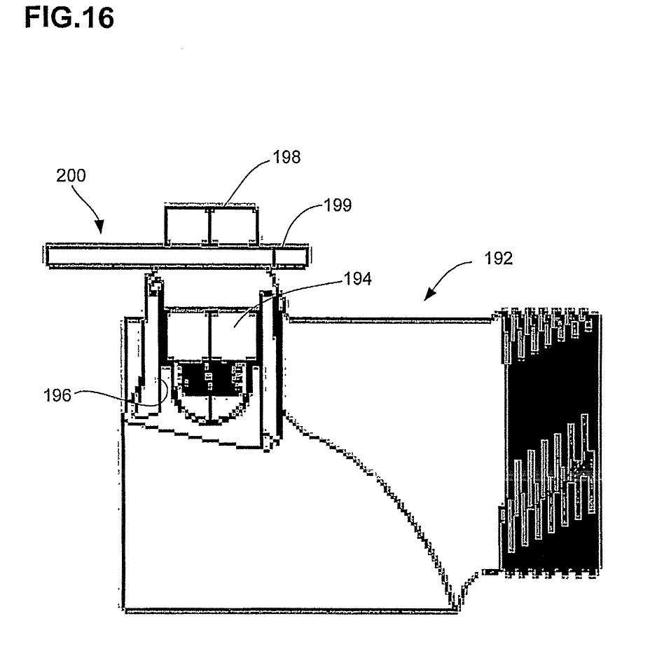

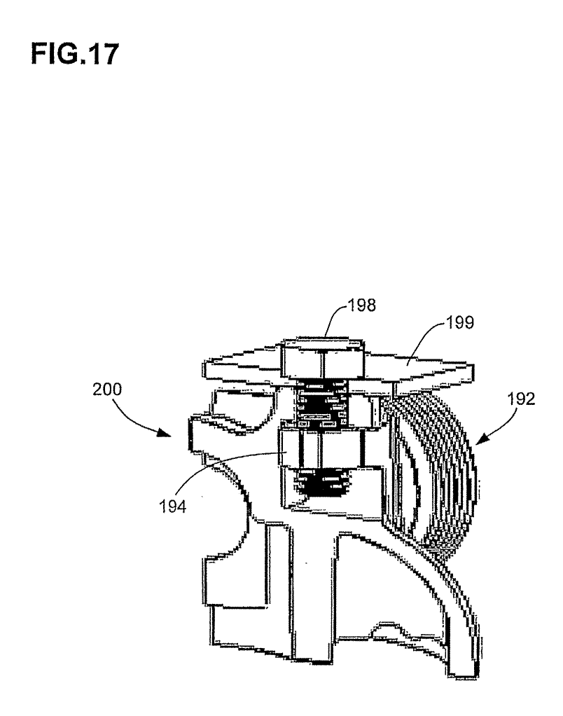

FIG. 15 shows an exploded, perspective view of a portion of the filter head 192. The pocket 196 can be seen with the hex nut 194 prior to insertion. FIG. 16 shows the filter head 192 of FIG. 15 after assembly of the hex nut 194 into the pocket 196 and the bolt 198 and washer plate 199 operably connected in place. FIG. 17 illustrates a sectioned, perspective view of the connector assembly 200 of FIGS. 15 and 16.

In use, to purify fluids using fluids of the type described herein, the filter arrangements are provided and spun onto a filter head. The fluid to be cleaned flows through the filter head, into the housing, through the filter cartridge, out of the filter housing, back through the filter head, and then out of the filter head. After a period of use, the filter media will become clogged or occluded. At this point, servicing of the filter is desired. To service the filter, the filter is removed by spinning it off the head. That is, the threaded engagement between the filter arrangement and the filter head is unmated. In some uses, the entire filter arrangement (the filter housing 22 plus the filter cartridge 24) is discarded and replaced with a new filter arrangement. The new filter arrangement 20 will be a new housing 22 having a new filter cartridge 24 installed therein. The new filter arrangement is then connected to the filter head by spinning it on.

1. A fluid filter arrangement comprising:
(a) a housing having a wall defining a closed end, an open end, and an interior volume;
(i) the housing wall defining a slot arrangement;
(ii) said housing comprising a molded plastic;
(b) a filter cartridge oriented within said interior volume of said housing; said filter cartridge including filter media;
(c) a projection arrangement constructed and arranged to engage the slot arrangement in the housing wall and space said filter cartridge from said housing wall to define a fluid flowpath between said filter cartridge and said housing wall.

2. A fluid filter arrangement according to claim 1 wherein:
(a) said filter cartridge includes the projection arrangement with a plurality of projections extending therefrom.

3. A fluid filter arrangement according to claim 2 wherein:
(a) said filter cartridge includes the filter media forming a tubular construction with an open interior volume; and an end cap secured to a first end of said tubular construction of filter media; said end cap defining an aperture in fluid communication with said open interior volume;
(i) said end cap includes said projection arrangement.

4. A fluid filter arrangement according to claim 2 wherein:
(a) each of said projections includes: a pair of wings flexibly secured to the filter cartridge.

5. A fluid filter arrangement according to claim 4 wherein:
(a) each of said pair of wings forms a V-shape.

6. A fluid filter arrangement according to claim 4 wherein:
(a) there are at least two projections.

7. A fluid filter arrangement according to claim 4 wherein:
(a) each of said wings of said projections extends radially from the filter cartridge to engage the slot arrangement.

8. (canceled)

9. A fluid filter arrangement according to claim 1 wherein:
(a) said filter cartridge includes the filter media forming a tubular construction with an open interior volume; and an end cap secured to a first end of said tubular construction of filter media; said end cap defining an aperture in fluid communication with said open interior volume;
(i) said end cap includes said projection arrangement

10. A fluid filter arrangement according to claim I wherein:
(a) said housing includes a support arrangement along a side of the wall facing the interior volume; the support arrangement constructed and arranged to support the filter cartridge.

11. A fluid filter arrangement according to claim 10 wherein:
(a) the support arrangement includes a plurality of ribs extending into the interior volume.

12. A fluid filter arrangement according to claim 11 wherein:
(a) the ribs are arranged in spiral pattern.

13. (canceled)

14. A fluid filter arrangement according to claim 3 wherein:
(a) each of said projections includes: a pair of wings flexibly secured to the end cap of the filter cartridge in a manner to form a V-shape and extend radially from the end cap.

15. A fluid filter arrangement according to claim 1 wherein:
(a) said filter cartridge includes:
(i) the filter media forming a tubular construction with an open interior volume;
(ii) a first end cap secured to a first end of said tubular construction of filter media; said end cap defining an aperture in fluid communication with said open interior volume;
(iii) said filter media includes pleated media and a second end opposite of said first end;
(iv) a second end cap secured to said second end of said filter media;
(A) said second end cap being closed.

16. A filter cartridge comprising:
(a) a tubular construction of filter media defining an open interior volume; and
(b) a projection arrangement comprising a plurality of projections in radial extension from the tubular construction;
(i) at least some of the projections of the plurality of projections includes: a pair of wings flexibly secured to the tubular construction.

17. A filter cartridge according to claim 16 wherein:
(a) each of the pairs of wings is oriented in a manner to form a V-shape.

18. A filter cartridge according to claim 16 further comprising:
(a) an end cap secured to a first end of said tubular construction of filter media; said end cap defining a first central aperture in fluid communication with said open interior volume;
(i) the plurality of projections extending radially from the end cap.

19. A filter cartridge according to claim 18 wherein:
(a) said end cap includes a base, and a sidewall;
(i) said sidewall including a media-containing portion that forms a continuous wall around said filter media;
(A) said media-containing portion extending from said base and having an end;
(B) said media-containing portion being generally orthogonal to said base; and
(C) the plurality of projections extending radially from the media-containing portion of the end cap.

20. (canceled)

21. A filter cartridge according to claim 18 further including:
(c) a first seal arrangement on the first end cap positioned at a location to provide a larger seal diameter (DsA) than a diameter of the first central aperture;
(i) DsA being within the range of 0.85-1.15 DbA, inclusive, wherein:
(A) DbA is a diameter at which no net axial surface force on the first end cap A toward or away from the second end cap B, in use, results.

22. A filter assembly comprising:
(a) a filter head having a fluid flow inlet port and fluid flow outlet port; and
(b) a filter arrangement is releasably secured to said filter head; the filter arrangement including:
(i) a housing having a wall defining a closed end, an open end, and an interior volume;
(A) the housing wall defining a slot arrangement;
(B) said housing comprising a molded plastic;
(ii) a filter cartridge oriented within said interior volume of said housing; said filter cartridge including filter media;
(iii) a projection arrangement constructed and arranged to engage the slot arrangement in the housing wall and space said filter cartridge from said housing wall to define a fluid flowpath between said filter cartridge and said housing wall.

23. A filter assembly according to claim 22 wherein:
(a) the filter head comprises plastic.

24. A method of assembling a filter; the method comprising:
(a) inserting a filter cartridge and a projection arrangement into an open end of a molded plastic housing; and
(b) engaging projections on the projection arrangement against an arrangement of through slots defined by the housing to secure the filter cartridge in the housing.

25. A method according to claim 24 wherein:
(a) the filter cartridge includes an end cap having the projections extending therefrom;
(i) each of the projections including a pair of wings flexibly attached to the end cap;
(b) said step of engaging includes inserting a portion of the wings into the through slots defined by the housing.

26. A filter housing comprising:
(a) a plastic wall surrounding an interior volume an having a closed end and an open mouth;
(i) the wall having an interior side in communication with the interior volume;
(b) a plurality of ribs extending from the interior side and into the interior volume.

27. A filter housing according to claim 26 wherein:
(a) each rib of the plurality of ribs is generally parallel to adjacent ribs.

28. A filter housing according to claim 26 wherein:
(a) each rib of the plurality of ribs extends obliquely along the interior side.

29. (canceled)

30. A filter housing according to claim 26 wherein:
(b) the plastic wall defines a plurality of closed through slots extending through the wall along a portion of the wall adjacent to the mouth.

31. A filter housing according to claim 26 wherein:
(a) the housing further defines a thread arrangement.

32. (canceled)

33. A fluid filter arrangement comprising a filter housing according to claim 26 and further comprising:
(a) a filter cartridge oriented in the interior volume;
(i) the ribs providing support to the filter cartridge.

34. A filter head comprising:
(a) a molded plastic block having a center tube, an outer tube, and defining a first fluid flow passageway, and a second fluid flow passageway; said outer tube circumscribing said center tube;
(i) said first fluid flow passageway having a first port;
(ii) said second fluid flow passageway having a second port;
(iii) said outer tube defining an end, an outer tube end port at said end, and an outer tube flow passageway between said first fluid flow passageway and said outer tube end port; and
(iv) said center tube defining a center tube flow passageway and a center tube end port; said center tube flow passageway being between said center tube end port and said second fluid flow passageway.

35-39. (canceled)
